(19) United States
(12) Patent Application Publication
(10) Pub. No.: US 2005/0046623 A1
(43) Pub. Date: Mar. 3, 2005

(54) Display adapter

(76) Inventor: Andreas Kaudel, Berlin (DE)

Correspondence Address: MICHAEL BEST & FRIEDRICH, LLP, 100 E WISCONSIN AVENUE, MILWAUKEE, WI, 53202, US

(21) Appl. No.: 10/894,642

(22) Filed: Jul. 20, 2004

(30) Foreign Application Priority Data
Aug. 11, 2003 (DE) 203 12 372.7

(51) Int. Cl. G09G 5/00

(52) U.S. Cl. 345/204

(57) ABSTRACT

The present invention relates to a display adapter to allow the automatic detection and configuration of a display device by a graphic card, independently of the graphic controller used by the graphic card, and to a corresponding display system. In order to automatically detect the nature and configuration of the display device, the display adapter includes at least one memory device for the storage of address data which point to configuration data in a memory of the graphic card, a first interface to connect the display adapter with the graphic card, a second interface to connect the display adapter with the display device, a transmitter device to transmit address data read out of the memory device to the graphic card and a receiver/transmitter device for receiving display data from the graphic card and forwarding them to the display device.

### BACKGROUND OF THE INVENTION

1. Field of the Invention

The present invention relates to display adapters, and in particular to a display adapter to allow the automatic detection and configuration of a display device by a graphic card which is at the same time independent of the graphic controller used by the graphic card. The invention also relates to a display system which contains the display adapter according to the invention.

2. Description of the Related Art

In order to connect a display device, especially a digital display, to a graphic card, an interface is required. A simple cable is often used for this. However, this means that a graphic card with a particular graphic controller is adapted to drive only one type of display device. To make it possible for a graphic controller also to drive different display devices, an interface module is additionally used, which comprises a microcontroller that controls the functions of the monitor. This means that the interface is fairly complex and expensive. An example of an interface module of this type is shown in published patent application US 2001/0030657 A1.

Alternatively, in order to control different display devices, a video card can be used which has two separate video ports to which either a tube screen or a liquid crystal screen can be connected, as suggested in published patent application US 2002/0149541 A1.

The disadvantage of the above solutions is that the entire arrangement is very complex and expensive. With the solution described in US 2002/0149541 in particular, it is not a simple interface, but rather a complete video card which would have to be exchanged if a different digital display were used.

### SUMMARY OF THE INVENTION

In order to overcome the above problems, a display adapter is provided that may improve the interface between the graphic card and a display device in such a way that the nature and configuration of the display device can be automatically detected and the display adapter is, at the same time, independent of the graphic controller used in each case. In addition, this is to be done in the simplest and cheapest way possible.

According to one embodiment of the present invention, a display adapter to allow the automatic detection and configuration of a display device by a graphic card comprises: at least one memory device for the saving of address data which point to configuration data in a memory of the graphic card; a first interface for connecting the display adapter with the graphic card; a second interface to connect the display adapter with the display device; a transmission device for the transmission of address data read out of the memory device to the graphic card; a receiver/transmitter device for receiving display data from the graphic card and forwarding them to the display device.

The present invention is based on the idea that a display adapter which is positioned between the graphic card and the display device increases the flexibility of the arrangement and reduces the complexity if the display adapter only contains address data which point to the configuration data required for the display device. The actual configuration data, which depend on the one hand on the graphic controller in question and which require, on the other hand, a relatively large amount of storage space and organisational resources, are saved on the graphic card itself. Because of the fact that the graphic controller reads the actual configuration data that are used by the graphic controller to send the necessary display data to the display device via the display adapter from a table which is saved in a storage device inside the graphic card, a very high level of flexibility can be reached in terms of the graphic card and the connectable display device. The solution according to the invention can advantageously guarantee that existing systems can be upgraded and retrofitted. The entire arrangement requires a minimal amount of configuration.

According to a further development of the present invention, a receiver/transmitter device which is provided for receiving the display data from the graphic card and for forwarding the same to the display device on the display adapter comprises a data modification device for modifying the display data. In this way, the data required to operate the connected display device can be converted into a form which can be processed by the display device.

If the display adapter according to the present invention is used for a digital display, preferably an LCD panel, extensive compatibility with existing standard market display devices can be achieved, since many different LCD panels can be operated with similar configuration data.

If a simple serial data memory, preferably an EEPROM, is used as the storage device, this solution offers the advantage of being a particularly low-priced, simple realisation of the display adapter.

According to an advantageous further development of the present invention, the receiver/transmitter device is only formed by a receiver which is integrated on the display adapter. With this solution, the costs and complexity for the actual display adapter can be kept low and the transmitter normally integrated in the graphic controller is used as the transmitter.

If an inter IC bus interface, which is often also described as an I²C bus interface, is used as the interface between the display adapter and the graphic card, this has the advantage that low-cost standard components can be used for the data transmission between the individual components.

In order to provide, for example, the control signals necessary for controlling the brightness of the background lighting, known as the backlight, the data modification device can include a D/A converter according to an advantageous further development.

According to a further advantageous embodiment, the data modification device also includes at least one voltage regulator and at least one power switch for the provision of the supply voltage required by the display device.

The display adapter according to the invention can be realised in a particularly compact and cheap way as a printed circuit on a printed circuit medium such as a printed circuit board (PCB). The electronic components required, and also the connectors needed for the interfaces, are connected with printed conductors provided on the circuit board by, for example, soldered connections.

To connect the display adapter on the one hand with the graphic card and on the other hand with the display device, flexible flat conductors and corresponding connectors can be provided. In particular if both interfaces are provided with a flat conductor, extensive geometric flexibility can be achieved. Alternatively, of course, the display adapter can also be fixed directly by means of a connector either to the graphic card or to the display device.

An advantage of using LVDS (low voltage differential signalling) for data transmission is that electromagnetic interference can be reduced through the use of the LVDS transmission technology. In addition, the cables can be smaller and thinner. This transmission technology also means that data mapping is independent of the manufacturer. The use of standard components means that the entire system can be carried out at a low price.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention as illustrated in the accompanying drawings, wherein:

FIG. 1 illustrates a block diagram of a display system with a display adapter according to a first embodiment;

FIG. 2 illustrates a block diagram of a display system according to a second embodiment;

FIG. 3 illustrates a perspective view of the display adapter according to a further embodiment.

### DETAILED DESCRIPTION OF THE INVENTION

The illustrated embodiments of the present invention will be described with reference to the figure drawings, wherein like elements and structures are indicated by like reference numbers.

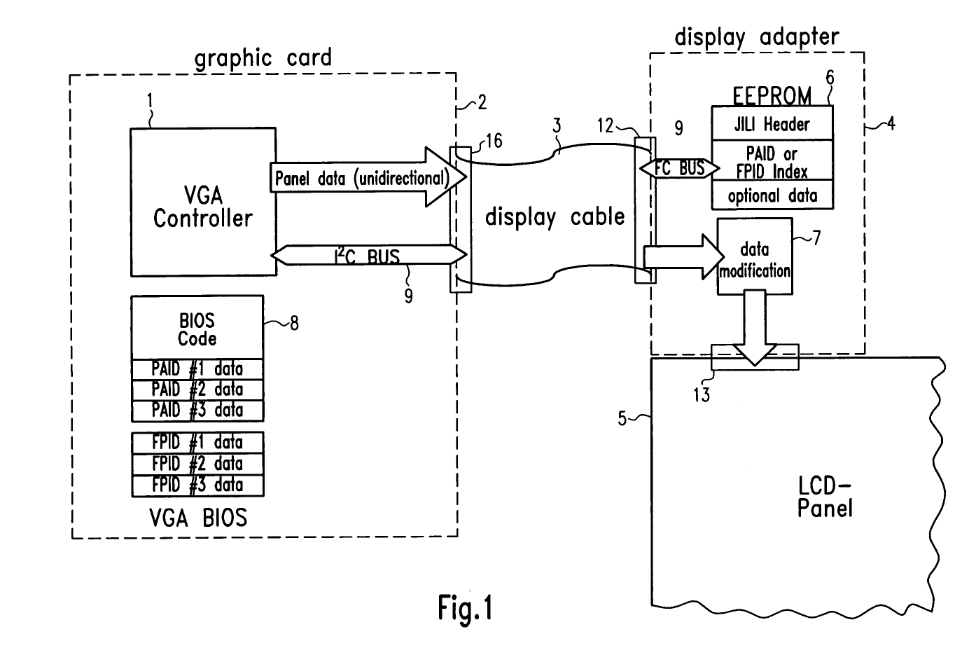

Referring now to FIG. 1, a display system according to the present invention comprises a VGA controller 1 which is arranged on a graphic card 2 and is connected by a display cable 3 to a display adapter 4. The display adapter 4 is connected via an interface to a display device 5, in this case an LCD panel. On the display adapter 4, there are provided a serial EEPROM 6 and a data modification device 7. The VGA controller 1 on the graphic card 2 has access to a BIOS (basic input/output system) 8 in which the configuration data are stored. The configuration data are transmitted between the VGA controller 1, the display adapter 4 and the LCD panel 5 via an I²C bus 9. The display data from the VGA controller 1 for the LCD panel 5 are sent by LVDS 9 firstly to the data modification device 7 on the display adapter 4 in order to be transmitted then to the LCD panel 5. The serial EEPROM 6 on the display adapter 4 contains the address data for the configuration data for the relevant LCD panel 5 in the BIOS 8.

The following steps are necessary for the automatic detection and configuration of a display device, for example an LCD panel, on different implementations of a VGA controller 1. The address of the configuration data from the LCD panel 5 is requested by the VGA controller 1. This address points to the BIOS 8 from which the VGA controller 1 reads in the necessary configuration data. The VGA controller 1 is then configured accordingly. The display data determined in this way are transmitted by the VGA controller to an interface and received by the LCD panel.

The VGA controller 1 requests the address of the configuration data for the LCD panel 5 from an EEPROM 6 on the display adapter 4. This is done via an I²C bus 9. The configuration data are read in by the VGA controller 1 from a table in the BIOS 8. This table contains at least one panel adapter ID or a flat panel ID. The display data that are transmitted by the VGA controller 1 to the interface contain, in addition, information on brightness control, voltage regulation and for switching the supply voltage.

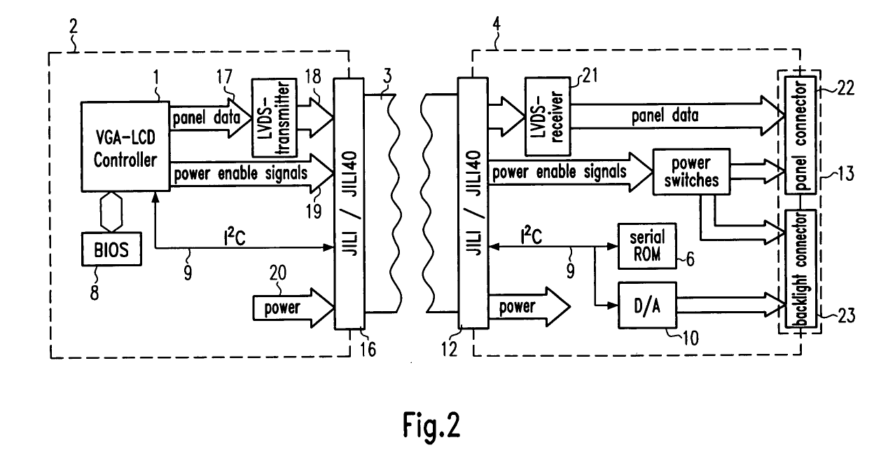

FIG. 2 shows a further block diagram for the display adapter 4 in a typical application environment.

With the display system shown in FIG. 2, the display adapter 4 according to the invention is connected via a 40-pole flat flexible cable (FFC) with the interface 16 of the graphic card 2. On the graphic card, a VGA LCD controller 1 is integrated which is connected with a BIOS 8. The VGA controller 1 switches data which are to be sent to the display device to an LVDS transmitter 17, which is integrated in the graphic card. From the graphic card 2, in addition to the configuration data 18, display data 19 and up to 4 timing signals 20 are output via the graphic card interface 16 to the display adapter 4. The display data 18 are received by an LVDS receiver 21 in the display adapter 4 and output to a panel connection 22, which is part of the interface 13 to the display. Power switches 11 switch the supply voltage both at the panel connection 22 and at a backlight connection 23.

The D/A converter 10 is responsible for the brightness control of the backlight. If display devices using what is called the Super Twisted Nematic LCD technology (STN panels) are used, a digital potentiometer is responsible for contrast control. The actual voltage regulation and the switching of the supply voltage for the panel and backlight must be switched in the correct time sequence, depending on the panel in question. For this, the power switch 11 receives the relevant time signals 19 from the graphic card 2.

The following explains the process of the display configuration in more detail using the arrangement drawn in FIG. 2.

During the VGA-BIOS initialisation, the I²C bus 9 is scanned as regards the configuration of the EEPROM 6. The EEPROM is detected using a particular header.

Data registers which are specific to the VGA controller 1 are stored in a particular area of the BIOS 8. FPID (flat panel identification) or PAID (panel adapter identification) are 32-bit indices which are saved on the EEPROM 6 on the display adapter 4. The data sets in the register are selected by FPID or PAID. Here, the BIOS 8 initially reads the FPID. If this is greater than 0, the table is checked for the correct entry. If available, this is then copied to the BIOS 8. If, on the other hand, either the FPID is not defined or no entry is found in the area, the PAID is used instead. This mechanism implements that special panel settings can also be processed if no standard cable is used. The end of the data packages in the EEPROM 6 of the display adapter 4 must be marked by a special identification.

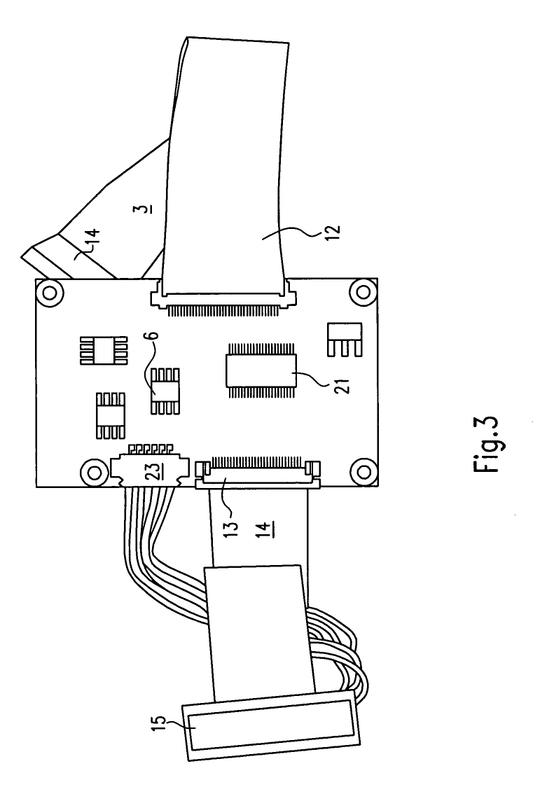

A possible realisation of the display adapter is shown in FIG. 3 in a perspective view. Here, the display adapter is made up as an independent card on a printed circuit board (PCB). The interfaces 12, 13 on the PCB to the graphic card 2 or to the display device 5 are made in each case as connections to a flat flexible cable. Using a connector 16, the flat flexible cable 3 is connected to the graphic card, and the flat flexible cable 14 is connected to the panel in question with the panel connector 15. The LVDS receiver 21 and the EEPROM 6 are arranged on the PCB as integrated modules. The backlight connection 23 is made here as a separate cable harness. However, integration into the cable 14 would also be possible, of course. During operation, the display adapter 4 is enclosed in a corresponding housing which, however, is not shown in this figure for greater clarity.

Naturally, the display adapter 4 shown in FIG. 3 can also be carried out differently. However, it is an advantage in any case if it is built as a separate module which can be connected in subsequently and which can be switched on via two multiway connectors between the computer and the display device. This allows a later problem-free retrofitting of existing display systems with a display adapter according to the invention.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention.

In addition, those areas in which it is believed that those ordinary skilled in the art are familiar have not been described herein in order not to unnecessarily obscure the invention described herein.

Accordingly, it is to be understood that the invention is not to be limited by the specific illustrated embodiments but only by the scope of the appended claims.

1. A display adapter for automatic detection and configuration of a display device by a graphic card, said display adapter comprising:
at least one memory device for saving address data which point to configuration data in a memory of the graphic card;
a first interface for connecting the display adapter with the graphic card;
a second interface to connect the display adapter with the display device;
a transmission device for the transmission of address data read out of the memory device to the graphic card;
a receiver/transmitter device for receiving display data from the graphic card and forwarding the display data to the display device.

2. The display adapter according to claim 1, wherein the receiver/transmitter device has at least one data modification device for modifying the display data before being forwarded to the display device.

3. The display adapter according to claim 1, wherein the display device is a digital display.

4. The display adapter according to claim 1, wherein the memory device is a serial data memory.

5. The display adapter according to claim 1, wherein the receiver/transmitter device is an LVDS receiver.

6. The display adapter according to claim 1, wherein the first interface is an Inter IC bus interface.

7. The display adapter according to claim 2, wherein the data modification device comprises a D/A converter for generating analogue signals transmitted to the display device.

8. The display adapter according to claim 2, wherein the data modification device further includes at least one voltage regulator and at least one power switch for providing at least one power voltage for the display device.

9. The display adapter according to claim 1, further comprising a circuit carrier on which electronic components of the display adapter are built up.

10. The display adapter according to claim 1, adapted to be connected with the graphic card by means of a flexible flat conductor and a connector.

11. The display adapter according to claim 1, adapted to be connected with the display device by a flexible flat conductor and a connector.

12. A system with a display device and a computer device containing a graphic card, said system having a display adapter for automatic detection and configuration of the display device by the graphic card, wherein the display adapter comprises:
at least one memory device for saving address data which point to configuration data in a memory of the graphic card;
a first interface for connecting the display adapter with the graphic card;
a second interface to connect the display adapter with the display device;
a transmission device for the transmission of address data read out of the memory device to the graphic card;
a receiver/transmitter device for receiving display data from the graphic card and forwarding the display data to the display device.

13. The system according to claim 12, wherein the graphic card comprises a graphic controller to control the display device.

14. The system according to claim 12, wherein the display device is a digital display.
